(19) United States
(12) Patent Application Publication
(10) Pub. No.: US 2008/0061168 A1
(43) Pub. Date: Mar. 13, 2008

(54) SPRAY HEAD

(75) Inventor: ERNST SCHEIDT, Dachau (DE)

Correspondence Address: Henry M. Feiereisen;Henry M. Feiereisen, LLC, Suite 4714, 350 Fifth Avenue, New York, NY, 10118, US

(73) Assignee: KRAUSS MAFFEI GMBH, Munchen (DE)

(21) Appl. No.: 11/940,611

(22) Filed: Nov. 15, 2007

Related U.S. Application Data
(63) Continuation of application No. PCT/EP2006/061812, filed on Apr. 25, 2006.

(30) Foreign Application Priority Data
May 20, 2007 (DE) 10 2005 023 233.7

(51) Int. Cl. B05B 7/06

(52) U.S. Cl. 239/428; 239/422; 239/583; 239/433

(57) ABSTRACT

A spray head for releasing a material made at least of two reactive components includes material supplies for providing two material components and a reciprocating cleaning and control piston Substantially provided in the cleaning and control piston is a mixing chamber which is fluidly connectable to material supplies for receiving and mixing the two material components, when the cleaning and control piston is in a first position. Fluidly connected to the mixing chamber is also a discharge channel for discharging the mixed material components. When the cleaning and control piston is moved to a second position, an air and/or liquid supply is fluidly connected to the mixing chamber so as to allow introduction of purging air or flushing agent to carry out a cleaning process.

### CROSS-REFERENCES TO RELATED APPLICATIONS

This application is a continuation of prior filed copending PCT International application no. PCT/EP2006/061812, filed Apr. 25, 2006, which designated the United States and has been published but not in English as International Publication No. WO 2006/122865 and on which priority is claimed under 35 U.S.C. §120, and which claims the priority of German Patent Application, Serial No. 10 2005 023 233.7, filed May 20, 2005, pursuant to 35 U.S.C. 119(a)-(d), the content(s) of which is/are incorporated herein by reference in its entirety as if fully set forth herein.

### BACKGROUND OF THE INVENTION

The present invention relates, in general, to a spray head for releasing a material made at least of two reactive components.

Nothing in the following discussion of the state of the art is to be construed as an admission of prior art.

Spray heads can be used to mix a polyurethane material from the components polyol and isocyanate and to apply the mixture onto a surface (e.g. the surface of a molding tool). After both reactive components have reacted out, a thin plastic skin forms on the surface and can be peeled off. Such plastic skins can be back-foamed or back injection-molded so that a product can be created with a surface skin of polyurethane material that has a pleasant surface feel.

International publication no. WO 96/27484, published Sep. 12, 1996, describes a device for mixing miscible components, including a cleaning piston arranged in a mixing chamber. A drawback of this device is the possibility of the reactive mixture in the mixing chamber to settle in the cleaning piston, rendering the mixing device inoperative.

It would be desirable and advantageous to provide an improved spray head to obviate prior art shortcomings.

### SUMMARY OF THE INVENTION

According to one aspect of the present invention, a spray head for releasing a material made at least of two reactive components includes a first material supply for a first component, a second material supply for a second component, a reciprocating cleaning and control piston, a mixing chamber substantially provided in the cleaning and control piston and fluidly connectable to the first and second material supplies for receiving and mixing the first and second components, when the cleaning and control piston is in a first position, a discharge channel fluidly connectable to the mixing chamber for discharging the mixed first and second components, and an air and/or liquid supply which is fluidly connected to the mixing chamber when the cleaning and control piston is in a second position.

In accordance with the invention, the mixing chamber is arranged substantially in the reciprocating cleaning and control piston. The cleaning and control piston is hereby constructed in such a manner that in cooperation with the material supplies, components can be fed to the mixing chamber and this mixture can then also be discharged in the discharge channel, when the piston is in at least one position, i.e. first position. In at least a second position of the cleaning and control piston, the mixing chamber can be fluidly connected with the air and/or liquid supply to implement the flushing process. As a result, the mixing chamber as well as the discharge channel and all other passages in the cleaning and control piston can be cleaned by being blown out or flushed so as to prevent a hardening or clogging in this region, which would cause a choking of the spray head.

The discharge channel may be arranged, for example, in a thin and barb-like spray lance by which otherwise inaccessible sites can also be reached. On an outlet side of the discharge channel and in particular on an outlet side end of the spray lance is a spray nozzle by which the mixed material can be applied in the form of a particular spray jet and at a desired spray distribution onto the surface.

In order to assure a desired and constant product quality, it is oftentimes necessary to circulate the starting materials that have not yet mixed with one another at a moment, when no spraying process is carried out. A return flow channel is hereby provided via which a recirculation can be realized at least temporarily.

According to another feature of the present invention, a valve may be arranged in each of thee material supplies device controlling the material flow. In particular, the flow path to the mixing chamber can then be cleared, when the return flow in the return flow channel is cut.

According to another feature of the present invention, the valve may be constructed in the form of a non-return valve. Such a non-return valve opens, when the return flow via the return flow channel is cut, and, as a result, a pressure increase is encountered in the material supply. As soon as a certain pressure causes the non-return valve to open, the respectively reactive material component can then be fed to the mixing chamber. When the return flow channel is cleared again to enable the material component to flow back, pressure drops correspondingly, the non-return valve closes, and a further transport to the mixing chamber is blocked. Other options for the implementation of such a valve are, of course, also possible.

A spray head according to the present invention is thus compact in structure and easy to clean.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic plan view of a first embodiment of a spray head according to the present invention;

FIG. 2 is a side view of the spray head of FIG. 1;

FIG. 3 is a sectional view of the spray head of FIG. 1, taken along the line A-A in FIG. 2;

FIG. 4 is an enlarged detailed view of the area encircled in FIG. 3 and marked “B”;

FIG. 5 is a schematic sectional view of a second embodiment of a spray head according to the present invention in a first operative position, and

FIG. 6 is a schematic sectional view of the spray head of FIG. 5 in a second operative position.

### DETAILED DESCRIPTION OF PREFERRED EMBODIMENTS

Throughout all the Figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

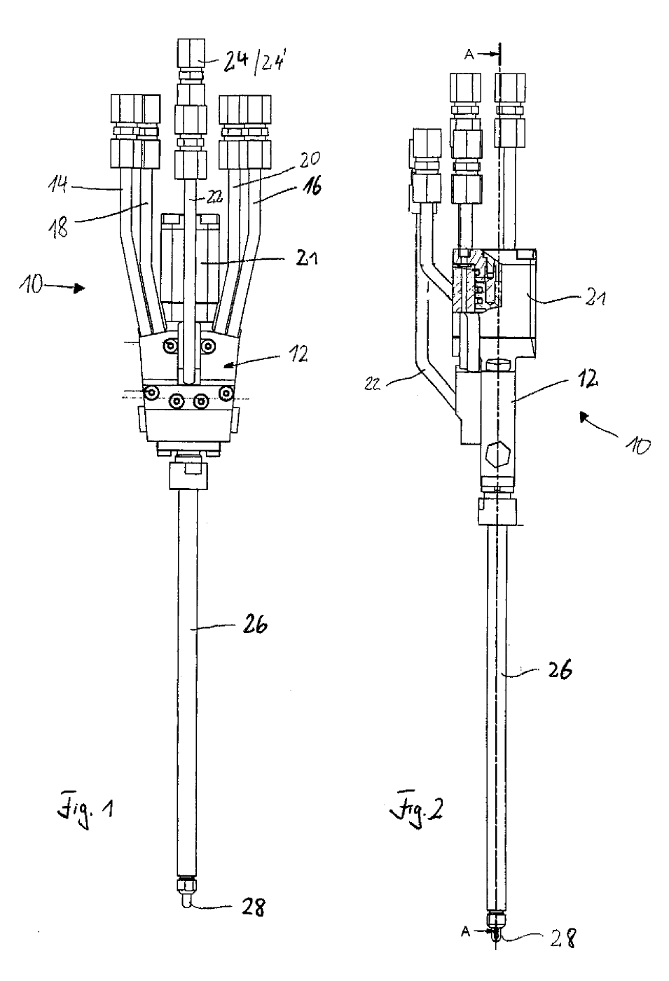

Turning now to the drawing, and in particular to FIG. 1, there is shown a schematic plan view of a first embodiment of a spray head according to the present invention, generally designated by reference numeral 10 and typically installed in overall system, which is not shown here in detail for the sake of simplicity, as it does not form part of the invention. The spray head 10 includes a mixing body 12 which connected to a plurality of inlets and outlets for reactive starting materials and other media. A first material component of a reactive material mixture to be produced is fed via a supply line 14 to the mixing body 12. The first material component can be returned again to a not shown tank via a return line 18, when no spraying process is carried out. Both supply line 14 and return line 18 may be connected to a high pressure system (not shown) to provide the material components at a desired pressure, when fed from the tank via a pump or returned again to the tank.

A second material component of the reactive material mixture is fed via a supply line 16 which also ports into the mixing body 12. Leading back from the mixing body 12 is a return line 20 for feeding back the second material component in the event no spraying takes place and thus nothing is discharged from the spray head.

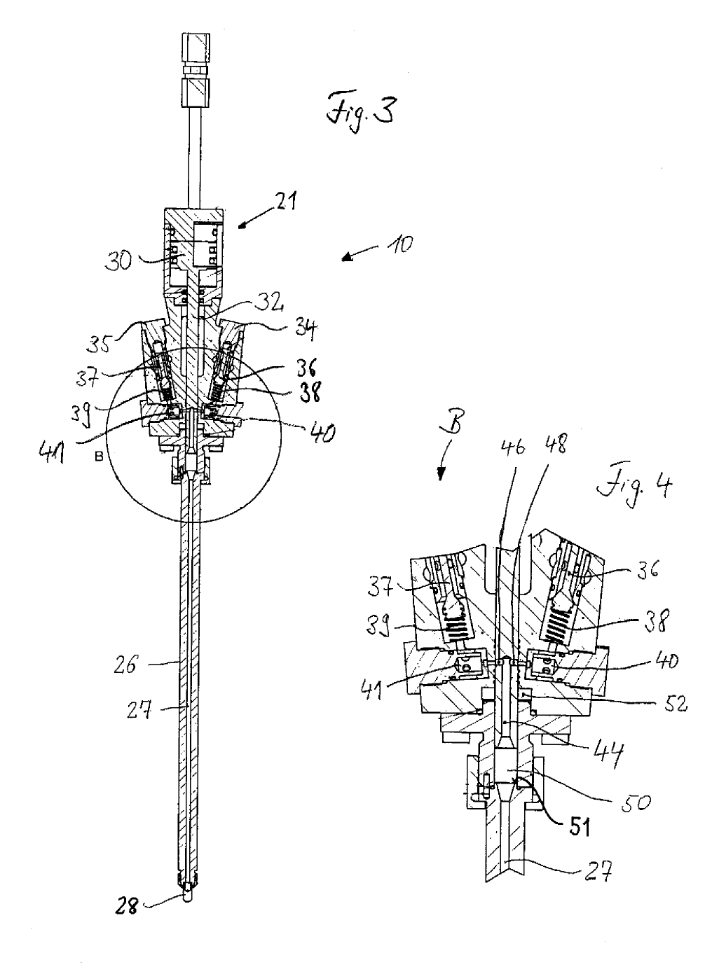

As shown in the side view of FIG. 2, the spray head 10 has an air and/or flushing agent supply line 22 which is also connected to the mixing body 12 and is provided to feed purging air to the mixing body 12, as will be described furtherbelow.

Further provided on the mixing body 12 is a hydraulic piston drive 21 which has a housing secured to the housing of the mixing body 12 and includes a hydraulic piston 30 whose function will be described furtherbelow. The hydraulic piston drive 21 is connected to two hydraulic lines 24, 24′, namely a hydraulic supply line and a hydraulic return line.

Arranged to a lower area of the mixing body 12 is a spray lance 26 which terminates in a spray nozzle 28 by which the reactive mixture comprised of the material components can be released and applied onto an unillustrated surface.

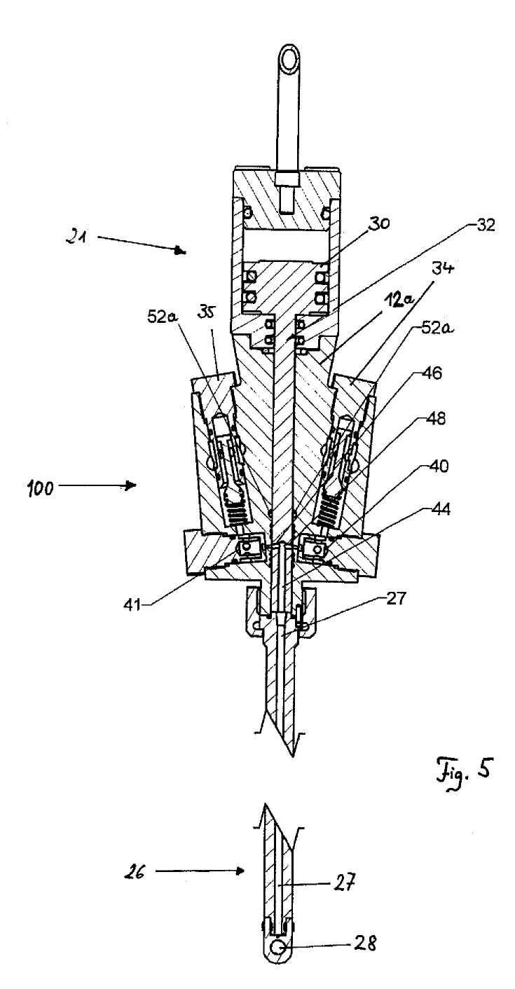

As shown in FIG. 3, and in particular in FIG. 4, two valve units 34, 35 are provided in the mixing body 12 which the two material supply lines 14, 16 port into respectively. Both valve units 34, 35 are constructed in the form of non-return valves, which accommodate valve needle 36, 37, respectively. The valve needles 36, 37 are biased by valve springs 38, 39 to normally seek a position against respective valve seats so as to cut a flow communication between the supply lines 14, 18, and a mixing chamber 44. In this position of the valve needles 36, 37, the supply line 14 is however fluidly connected to the return line 18 and the supply line 16 is fluidly connected to the return line 20 to establish a recirculation of both starting materials, when they are not yet mixed.

However, the return flow can be cut. This can be realized by respective—here not shown—valves. Thus, when the material return flow is barred, pressure increases in the supply lines 14, 18. When the pressure reaches a certain level above the preset spring tension, the valve needles 36, 37 are pushed back in opposition to the resistance of the corresponding springs 38, 39. As a consequence, the respective material component is able to reach a first nozzle and a second nozzle 40 or 41, respectively, via a hollow valve space and a channel arranged in the mixing body housing. Further bores extend from the nozzles 40, 41 to a central bore 50 which accommodates a reciprocating cleaning and control piston 32.

The internal structure of the mixing body 12 is shown in greater detail in FIG. 3 and in particular in FIG. 4. The cleaning and control piston 32 which is able to move back and forth in the central bore 50 of the mixing body 12 is connected at its upper end with the hydraulic piston 30 which, when suitably acted upon, moves back and forth in a hydraulic cylinder of the hydraulic piston drive 21. The cleaning and control piston 32 is operated by routing hydraulic oil via the hydraulic lines 24, 24′ to one or the other side of the hydraulic piston 30 to displace the hydraulic piston 30 and thereby the cleaning and control piston 32.

The cleaning and control piston 32 has a lower region formed with a coaxial bore which extends downwardly and has a widening open end and which serves as a mixing chamber 44. Near an upper end of the mixing chamber 44 are two diametrically opposing small passageways 46, 48 to provide a flow communication between the mixing chamber 44 and the outer side of the cleaning and control piston 32.

Immediately adjacent to the lower end of the mixing body 12 is a spray lance 26 which accommodates a discharge channel 27. The spray lance 26 is attached to the mixing body 12, with the discharge channel 27 forming a prolongation of the bore 50 in coaxial manner and porting on an outlet side of the spray lance 26 in a spray nozzle 28 which is so configured as to produce a spray jet in a desired manner.

As can be seen more clearly in FIG. 4, which shows in greater detail the area marked “B” in FIG. 3, the cleaning and control piston 32 is able to move back and forth in the bore 50 within a certain stroke range (up and down). In an upper position, as depicted in FIG. 4, the passageways 46, 48 are in alignment with associated bores in the mixing body 12 so that both material components can be introduced into the mixing space 44 of the cleaning and control piston 32 via the valves 34, 35 and the nozzles 40, 41 as well as via the passageways 46, 48.

When the hydraulic piston 30 is acted upon to move the cleaning and control piston 32 downwards, the passageways 46, 48 shift also downwards, causing the outlets of both nozzles 40, 41 to be blocked by the cleaning and control piston 32. When the cleaning and control piston 32 has moved far enough downwards to a lower position, limited by a shoulder 51 of the spray lance 26, both passageways 46, 48 come into fluid communication with a chamber 52 which is connected to the air and/or flushing agent supply line 22. Purging fluid, such as air or a flushing agent, from a suitable fluid source can thus be conducted via the supply line 22 and the chamber 52 through the passageways 46, 48, the mixing chamber 44, the bore 50 and the discharge channel 27, and these hollow spaces can be liberated from reactive mixture.

The mode of operation of the spray head 10 is as follows. When switching a valve (not shown) in each of the return channels 18, 20 to allow passage, the material components recirculate from the supply lines 14, 16 without any substantial pressure buildup to the corresponding return lines 18, 20. When closing the valves in the return lines 18, 20, pressure increases in the supply lines 14, 17 and acts in opposition to the valve needles 36, 37 which are pressed by the preset tension of the springs 38, 39 against their valve seats. When the pressure buildup reaches a predetermined level, the valve needles 36, 37 are lifted off their valve seats to allow a throughflow of the material components through the valve space toward the respective nozzles 40, 41.

When the cleaning and control piston 32 is moved by the hydraulic piston 30 to the retracted (upper) position, as shown in FIG. 4, the material components from the supply lines 14, 16 can flow via the confronting passageways 46, 48 into the mixing chamber 44. As the passageways 46, 48 are placed in opposition to one another, the incoming component jets impact each another, thereby attaining an intimate mixing process to form a reactive material. The thus produced reactive material flows downwards in the mixing chamber 44, through the clear part of the bore 50 and enters the discharge channel 27. After flowing through the discharge channel 27, the mixed reactive material is released via the spray nozzle 28.

As soon as the valves in the return channels 18, 20 open again, pressure drops in the supply lines 14, 16 so that the non-return valves 34, 35 close again, when the pressure drops below the predetermined level and the springs 38, 39 force the valve needles 36, 37 against their valve seats. This concludes the spraying process.

Prior to the conclusion of the material supply, or simultaneously, or also subsequently, the cleaning and control piston 32 is moved downwards to the lower position by suitably acting upon the hydraulic cylinder 30 so that the flow connection between both nozzles 40, 41 and the passageways 46, 48 in the cleaning and control piston 32 is cut. As the cleaning and control piston 32 moves downwards, reactive material in the piston bore 50 is pushed out downwards as well. When the cleaning and control piston 32 reaches the lower position, the passageways 46, 48 are fluidly connected to the chamber 52 so that purging air or flushing agent from the supply line 22 is able to flow through the passageways 46, 48, the mixing chamber 44, and the discharge channel 27 to liberate all passages and spaces from residual reactive material mixture.

To initiate a next spraying process, the cleaning and control piston 32 is moved back to the upper position by the hydraulic piston 30 and the valves in the return lines 18, 20 are closed again, causing a pressure buildup in the supply lines 14, 16 to ultimately open the non-return valves 34, 35 to repeat the cycle, as described above.

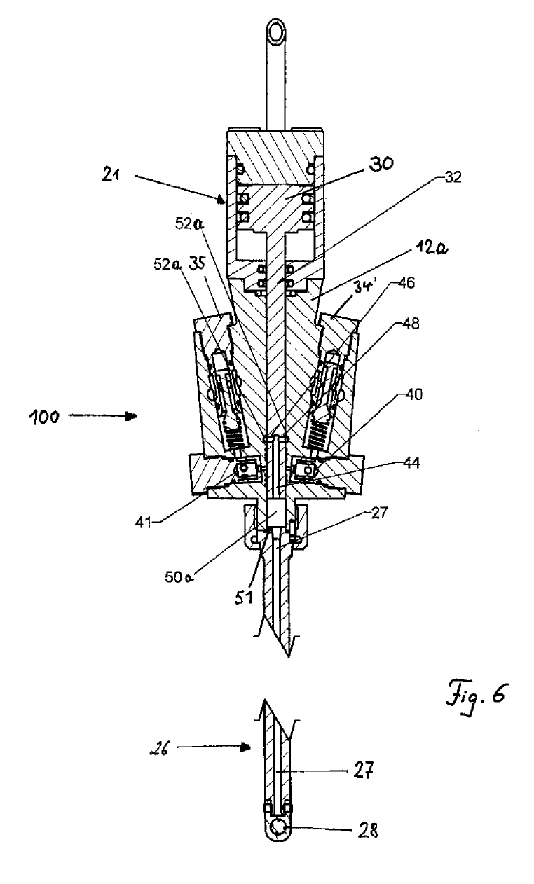

Turning now to FIG. 5, there is shown a schematic sectional view of a second embodiment of a spray head according to the present invention, generally designated by reference numeral 100. In describing the embodiment of FIG. 5, like parts of the spray head 100 corresponding with those of the spray head 10 in FIGS. 1-4 will be identified by corresponding reference numerals, followed by the distinguishing character “a” in case corresponding but modified elements are involved. The description below will center on the differences between the embodiments. In this embodiment, provision is made for a mixing body 12a having a different configuration as far as the air and/or flushing agent supply is involved. In this embodiment, the air and/or flushing agent supply in the housing of the mixing body 12a is positioned above the material supply. As a result of such construction of the mixing body 12a, reactive material mixture can be removed not only from the mixing chamber 44 and the discharge channel 27 but also the space between the cleaning and control piston 32 and the spray lance 26 can be cleaned.

As shown in FIG. 5, the mixing body 12a is configured in the absence of any substantial space between the mixing chamber 44 and the spray lance 26 during the mixing and discharge (spraying) process. This operational state in which the starting materials are introduced via the non-return valves 34, 35, the nozzles 40, 41 and the passageways 46, 48 is shown in FIG. 5.

When the mixing and discharge process should be stopped or interrupted, the material supply is stopped in a same manner as described with reference to the spray head 10, with the exception that the cleaning and control piston 32 now moves up instead of down. The upper position is shown in FIG. 6. As the cleaning and control piston 32 moves up from the lower position, shown in FIG. 5, a space 50a is formed between the cleaning and control piston 32 and the spray lance 26. Although material, e.g. from the discharge channel 27, may accumulate there, no new or additional material can reach the space 50a.

When the cleaning and control piston 32 reaches the upper position, a flow communication is established between the passageways 46, 48 and an annular groove 52a which is fluidly connected to the air and/or flushing agent supply line 22 and arranged above the passageways 46, 48 and thus the incoming material supply. As result, purging fluid, e.g. air or flushing agent, from a not shown supply source and entering the mixing body 12a via the annular groove 52a is able to flush the passageways 46, 48′, the mixing chamber 44, the space 50 downstream of the mixing chamber 44 and the discharge channel 27 in the spray lance 26.

The spray head 100 requires thus flushing of slightly less material than the spray head 10.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A spray head for releasing a material made at least of two reactive components, said spray head comprising:
a first material supply for a first component;
a second material supply for a second component,
a reciprocating cleaning and control piston;
a mixing chamber substantially provided in the cleaning and control piston and fluidly connectable to the first and second material supplies for receiving and mixing the first and second components, when the cleaning and control piston is in a first position;
a discharge channel fluidly connectable to the mixing chamber for discharging the mixed first and second components; and
an air and/or liquid supply which is fluidly connected to the mixing chamber when the cleaning and control piston is in a second position.

2. The spray head of claim 1, further comprising a mixing body accommodating the cleaning and control piston with the mixing chamber, and a spray lance mounted to the mixing body and accommodating the discharge channel.

3. The spray head of claim 2, further comprising a spray nozzle provided at a mixing body distal end of the spray lance on an outlet side of the discharge channel.

4. The spray head of claim 1, wherein the first material supply is adapted for connection to a return flow channel and the second material supply is adapted for connection to a return flow channel for allowing an at least temporary recirculation of the first and second components.

5. The spray head of claim 4, further comprising a first valve arranged in the first material supply and a second valve arranged in the second material supply.

6. The spray head of claim 5, wherein each of the first and second valves is constructed to permit a flow path to the mixing chamber, when the return flow is barred.

7. The spray head of claim 5, wherein each of the first and second valves is constructed in the form of a non-return valve.

8. The spray head of claim 5, wherein each of the first and second valves is spring-biased, with a spring tension being adjustable.

9. The spray head of claim 1, wherein the mixing body has a bore in which the cleaning and control piston is guided for back and forth movement, said air and/or liquid supply having an outlet channel formed in a surface of the bore and fluidly connected with passageways in the cleaning and control piston, when the cleaning and control piston is in the second position.

10. The spray head of claim 9, wherein the outlet channel is configured in the form of an annular groove.

11. The spray head of claim 9, wherein the outlet channel is positioned above the passageways.
